(19) United States
(12) Patent Application Publication
(10) Pub. No.: US 2006/0050424 A1
(43) Pub. Date: Mar. 9, 2006

(54) Exterior rearview mirror for vehicles, in particular for motor vehicles

(75) Inventors: Jürgen Tilg, Kirchheim (DE); Jörg Kuhn, Stuttgart (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH, Esslingen (DE)

(21) Appl. No.: 11/211,270

(22) Filed: Aug. 25, 2005

(30) Foreign Application Priority Data
Sep. 1, 2004 (DE) 102004042260.5

(51) Int. Cl. G02B 7/182

(52) U.S. Cl. 359/879

(57) ABSTRACT

Exterior rearview mirror for vehicles, in particular for motor vehicles. The exterior rearview mirror has a mirror body that is rotatably attached to a mirror base and whose operating position is determined by contact between at least one stop and at least one opposing stop. In order to design the exterior rearview mirror to ensure that the generation of noise in the mirror during driving or as a result of shocks is no longer bothersome, at least one noise damping device is associated with at least the area of contact between stop and opposing stop. As a result, the sound waves caused by the constant striking together of the stop and opposing stop are largely absorbed by the noise damping device so that the sound does not reach the outside, or does so to only a small degree. The exterior rearview mirror is suitable for use in motor vehicles.

### CROSS-REFERENCE TO RELATED APPLICATIONS

This application claims priority to German Patent Application No. 10 2004 042 260.5 filed Sep. 1, 2004.

### TECHNICAL FIELD

The invention concerns an exterior rearview mirror for vehicles, in particular for motor vehicles.

### BACKGROUND OF THE INVENTION

In exterior rearview mirrors, the stop and opposing stop rest against one another in the operating position of the mirror body. During driving or as a result of external influences on the mirror, for example when the car doors are slammed, small shocks arise that cause the stop to lift slightly from the opposing stop and fall back down upon it again. This causes clattering noises that drivers and passengers find bothersome.

The object of the invention is to design an exterior rearview mirror such that the generation of noise in the exterior rearview mirror during driving or as a result of shocks is no longer bothersome.

This object is attained in accordance with the invention in an exterior rearview mirror.

### SUMMARY OF THE INVENTION

As a result of the inventive design, the sound waves caused by the constant striking together of the stop and opposing stop are at least largely absorbed by the noise damping device so that the sound does not reach the outside, or does so to only a small degree. The clattering noises from the striking together of the stop and opposing stop are no longer audible.

Additional features of the invention are apparent from the other claims, the description, and the drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail below on the basis of two example embodiments shown in the drawings. The drawings show:

FIG. 1, an inventive exterior rearview mirror with a mirror body that is connected by an intermediate link to a mirror base,

FIG. 2, the exterior rearview mirror from FIG. 1 in a view as indicated by the arrow 11 in FIG. 1, but without the mirror body,

FIG. 3, a view in the direction of the arrow III in FIG. 2,

FIG. 4, a representation as in FIG. 3 with the intermediate link in the contact position on the mirror base,

FIG. 5, a view in the direction of the arrow V in FIG. 1,

FIG. 6, the detail VI in FIG. 2 in an enlarged view,

FIG. 7, a section along line VII-VII in FIG. 5,

FIG. 8, another embodiment of an inventive exterior rearview mirror in a view corresponding to FIG. 7,

FIG. 9-FIG. 11, additional embodiments of inventive exterior rearview mirrors in representations corresponding to FIG. 7.

### DETAILED DESCRIPTION OF THE PREFERRED EMBODIMENTS

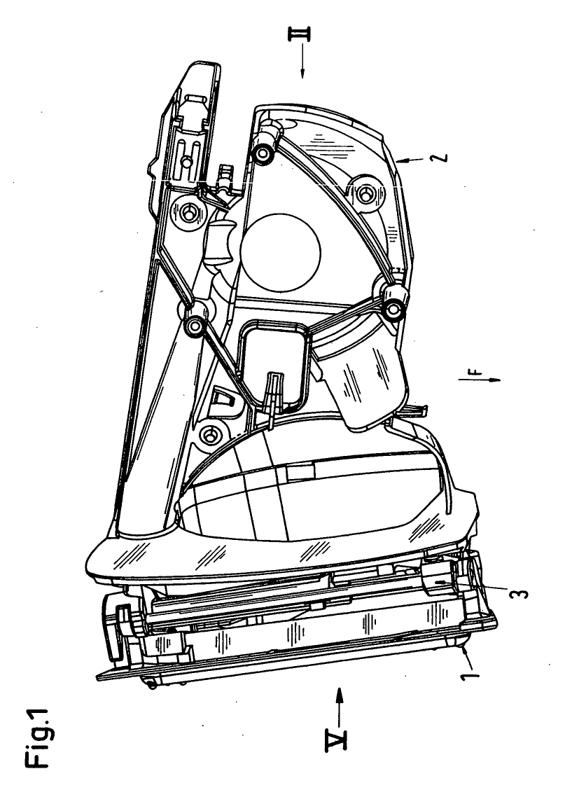

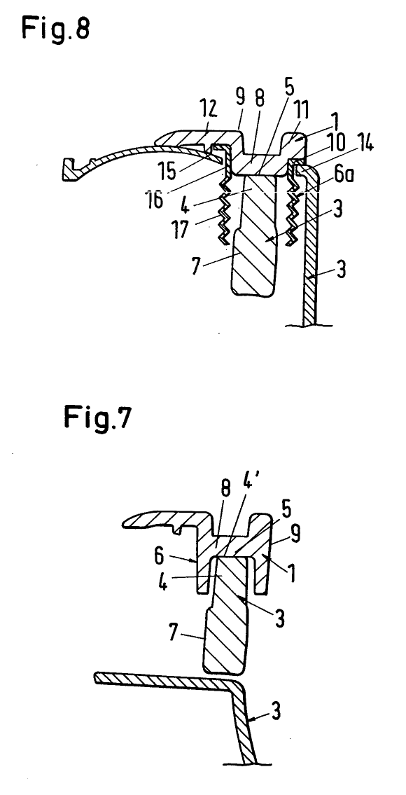

In the example embodiments shown, the exterior rearview mirror is attached to a motor vehicle door (not shown). The exterior rearview mirror has a mirror base 1, which is affixed to the vehicle door in a known manner. Swivel-mounted to the mirror base 1 is a mirror body 2, which can be pivoted in and opposite to the vehicle's direction of travel F (FIG. 1). The mirror body 2 is swivel-mounted to the mirror base 1 by means of an intermediate link 3. In the operating position shown in FIG. 1, the intermediate link 3 rests against the mirror base 1 with at least one stop 4 contacting at least one opposing stop 5 (FIGS. 4, 7).

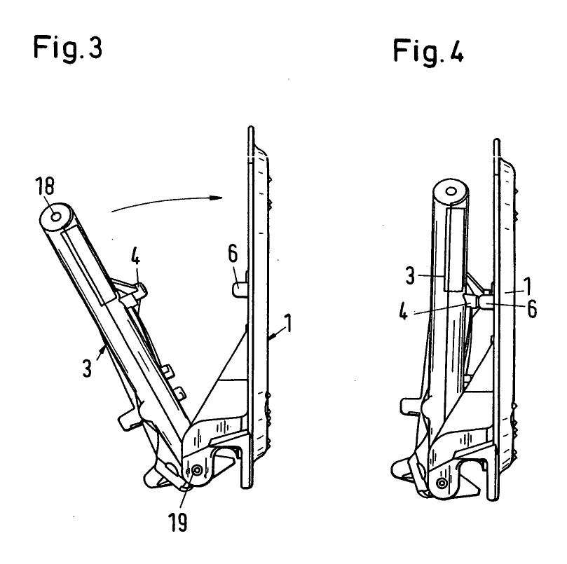

The intermediate link 3 is designed in the shape of a ring and pivots about two parallel axes 18 and 19 pointing toward the ground (FIG. 3). The intermediate link 3 is hinged by the axis 18 to the mirror body 2 and by the axis 19 to the mirror base 1. The pivot axes 18, 19 are designed such that they can come free from the corresponding bearings of the mirror body 2 and the mirror base 1. If an impact is exerted on the mirror body 2 forward in the direction of travel F, the mirror body 2 pivots together with the intermediate link 3 about the axis 18, while the pivot axis 19 comes free from the bearing of the mirror base 1. If the mirror body 2 experiences an impact opposite to the direction of travel F, it pivots together with the intermediate link 3 about the axis 19, while the pivot axis 18 comes free.

The mirror body 2 is advantageously folded out of its operating position, against the direction of travel F, into its rest position by means of a motor. The mirror body 2 is preloaded in the direction of its operating position by at least one spring (not shown).

In the drawings, the covers or housing of the mirror base 1 and mirror body 2 are not shown. The mirror body housing may accommodate the actuating drive for the mirror glass support plate, a heater, a turn signal repeater lamp, at least one perimeter light, a camera, sensors for an EC mirror glass, a transmitter and/or a receiver for a garage door opener, a GPS module for a navigation system, and the like. These components may be provided in any desired combinations. One or more of these components may also be accommodated in the mirror base housing.

The stop 4 is provided on a stiffening rib 7 of the intermediate link, while the opposing stop 5 in the example embodiment is composed of an outside of a base 8 of a dished profile section 9 of the mirror base 1. The stop 4 of the intermediate link 3 is surrounded by a noise damping device 6. This device is designed in the form of a sleeve and surrounds the stop 4 at a distance. During travel, shocks occur that cause the stop 4 to make small movements relative to the opposing stop 5. These movements cause clattering noises that are considered bothersome in conventional exterior rearview mirrors. The noise damping device 6 prevents the noises produced by these movements from reaching the outside. The axial length and the diameter of the noise damping device 6 are matched to one another such that the sound waves produced by the impact do not travel outward from the noise damping device 6, or only do so to a negligibly small extent. Preferably all sound waves are absorbed, so that the noises of the movements are not perceived.

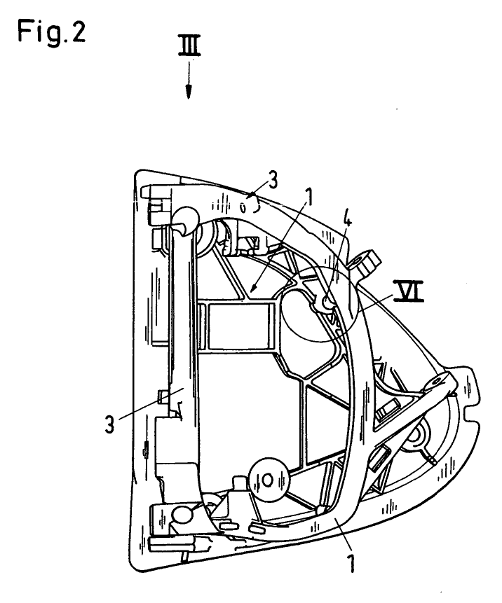

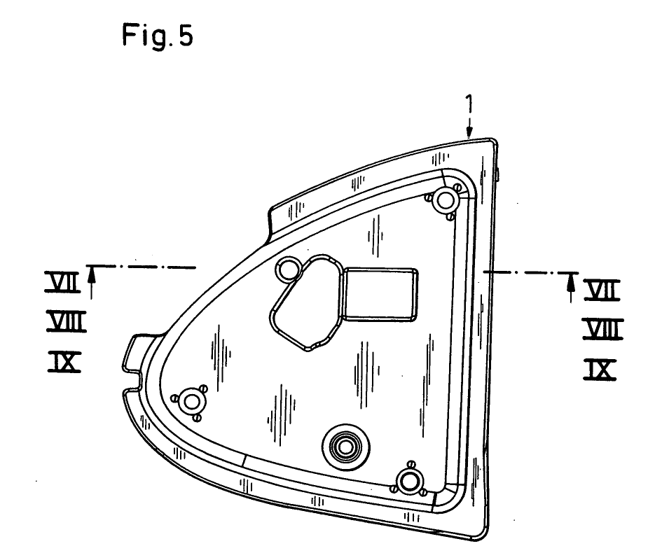

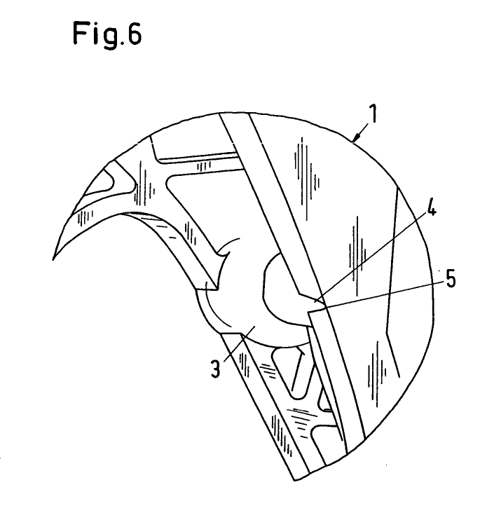

In the embodiment shown in FIGS. 1 through 7, the noise damping device 6 is designed as a single piece with the profile part 9 of the mirror base 1. Nearly the entire length of the stop 4 extends into the sleeve-like noise damping device 6.

In order to facilitate in and out movement of the stop 4 during pivoting of the mirror body 2 relative to the mirror base 1, the stop is designed to taper toward its free end. In addition, the walls of the noise damping device 6 taper toward the outside.

Of course, the noise damping device 6 can also be provided in the intermediate link 3. In this case, the noise damping device 6 extends to the opposing stop 5 on the mirror base side and surrounds it such that when the movement noises described occur, none of the sound waves, or only a negligibly small portion of them, escape from the noise damping device 6. It is also possible in this case for the noise damping device 6 to ensure optimal soundproofing. The noise damping device 6 can be designed as a single piece with the intermediate link 3, or as a separate part.

The noise damping can be improved by applying a damping material, such as a rubber coating or the like, to the stop 4 and/or the opposing stop 5.

The embodiment shown in FIG. 8 differs from the embodiment in FIGS. 1 through 7 in that, in place of having the noise damping device 6 designed as a single piece with the mirror base, it is provided with a separate noise damping device 6a of bellows-like design. This device is designed in the form of a sleeve with an outwardly angled collar 10, which in the example embodiment lies in a plane inclined to the axis of the opposing stop 5. The noise damping device 6a is partially clamped by the angled border 10 between radially outward projecting legs 11 and 12 of the profile part 9 having the base 8 and the edges 14 and 15 of the intermediate link 3 opposite thereto. In addition, the collar 10 is affixed to the mirror base 1 with a suitable adhesive.

The collar 10 is provided on the free end of a cylindrical sleeve section 16 that projects over the opposing stop 5 and transitions into a bellows section 17 that is many times longer in the axial direction. Its sleeve has a zigzag profile in cross-section. At least the bellows section 17 is made of elastomeric material, such as plastic, rubber, or the like, and extends over the entire length of the stop 4 to the region of the stiffening rib 7.

The noise damping device 6a or its bellows section 17 can be long enough that it rests against the mirror body housing under elastic deformation when the mirror body 2 is in the operating position. In this case, the area of contact or impact between the stop 4 and opposing stop 5 is encapsulated in full, making it possible to achieve an optimum soundproofing effect.

The noise damping devices 6, 6a described are provided by preference for exterior rearview mirrors of motor vehicles. However, they may be used anywhere that clattering noises caused by parts striking against one another need to be damped, for example in link joints that are not pushed or pulled into their stop position by spring preloading. An advantage in the example embodiments described is that the clattering noises that arise are not prevented by costly measures, but instead are damped by the noise damping device.

In advantageous fashion, two or more stops 4 and opposing stops 5 are provided on the intermediate link 3 and on the mirror base 1. Each of these is provided with the noise damping device 6, 6a described.

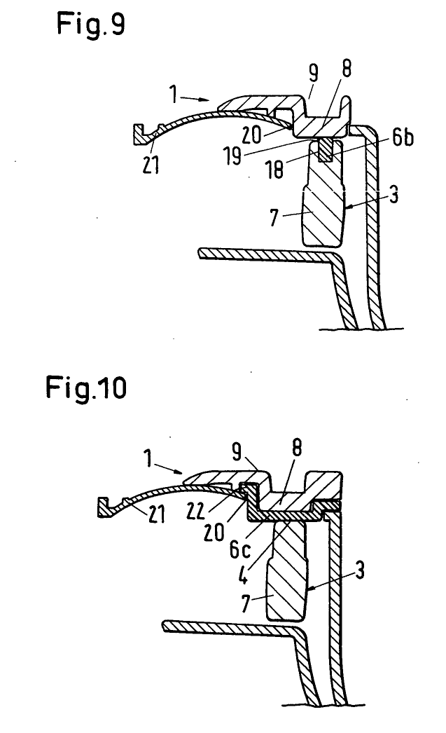

In the example embodiment in FIG. 9, the noise damping device 6b is composed of an insert of elastomeric material, which is placed in a recess 18 in the end face of the stiffening rib 7 of the intermediate link. The noise damping device 6b projects beyond the end face 19 of the stiffening rib 7. In the operating position of the mirror body 2, the intermediate link 3 contacts the base 8 of the profile section 9 of the mirror base 1 by means of this projecting part of the noise damping device 6b. The profile section 9 protrudes through an opening 20 of a cover 21 of the mirror base 1 in similar fashion to the embodiment in FIGS. 1 through 7. The cover 21 is advantageously made of plastic.

The noise damping device 6b is affixed in a suitable manner in the recess 18 in the stiffening rib 7.

In the example embodiment shown in FIG. 10, at least the base 8 of the profile section 9 of the mirror base 1 is covered by the noise damping device 6c. In advantageous fashion, this noise damping device is dished in design and surrounds the profile section 9 in the region of the base 8, and additionally in the region of the side walls. The noise damping device 6c again is made of an appropriate plastic and is affixed to the outside of the profile section 9 in a suitable way, preferably glued on.

The noise damping device 6c has an outwardly directed flange 22 projecting at right angles with which it interlocks with the edge of the opening 20 of the cover 21. In this way, the approximately dish-shaped noise damping device 6c is additionally secured in the installed position by positive locking.

In the operating position of the mirror body 2, the stiffening rib 7 of the intermediate link 3 rests against the noise damping device 6c. In this way, optimal soundproofing is achieved in this example embodiment as well.

The example embodiment in FIG. 10 has the advantage that the noise damping device 6c is designed as a plug-in part that is very easy to install. It is simply inserted through the opening 20, from the rear of the cover 21, far enough that the flange 22 of the noise damping part 6c contacts the inside of the cover 21. The outline of this noise damping part 6c is chosen such that it rests against the edge of the opening 20 in the cover 21.

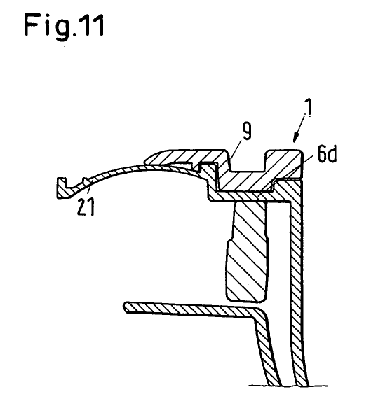

In the embodiment in FIG. 11, the cover 21 of the mirror base 1 is continuous in design, and in contrast to the example embodiments shown in FIGS. 1 through 6 and 8 through 19, has no opening. To this end, the cover 21 in the region of the profile section 9 is designed such that it makes full contact with the outer wall of the profile section 9. As evidenced by a comparison of FIGS. 10 and 11, in this case the noise damping device 6d has the same design as the noise damping device 6c except that, unlike that embodiment, it is designed as a single piece with the cover 21. The cover 21 can be made entirely of the noise-damping material. It is also possible, however, for the cover 21 to be made of noise-damping material only in the section that makes area contact with the profile section 9.

The exterior rearview mirror is provided with the intermediate link 3 in the example embodiment. However, the noise damping device 6, 6a can also be used in exterior rearview mirrors in which the mirror body 2 is coupled to the mirror base 1 with no intermediate link. The stop 4 is then provided on the mirror body 2.

The description of the invention is merely exemplary in nature and, thus, variations that do not depart from the gist of the invention are intended to be within the scope of the invention. Such variations are not to be regarded as a departure from the spirit and scope of the invention.

What is claimed:

1. Exterior rearview mirror for vehicles comprising a mirror body that is rotatably attached to a mirror base, said mirror having an operating position defined by contact between at least one stop and at least one opposing stop, wherein at least the contact area of the stop and opposing stop has associated with it at least one noise damping device.

2. Exterior rearview mirror according to claim 1, wherein the noise damping device surrounds the contact area.

3. Exterior rearview mirror according to claim 1, wherein the noise damping device is designed in the manner of a housing.

4. Exterior rearview mirror according to claim 1, wherein the noise damping device is designed in the manner of a sleeve.

5. Exterior rearview mirror according to claim 1, wherein the noise damping device is an insert piece.

6. Exterior rearview mirror according to claim 5, wherein the noise damping device is inserted in a cavity, from which it projects toward the stop or the opposing stop.

7. Exterior rearview mirror according to claim 5, wherein the noise damping device is inserted in an opening in a cover of the mirror base.

8. Exterior rearview mirror according to claim 7, wherein the noise damping device surrounds a profile section of the mirror base.

9. Exterior rearview mirror according to claim 7, wherein the noise damping device interlocks with the edge of the opening of the cover.

10. Exterior rearview mirror according to claim 1, wherein the noise damping device is designed as a single piece with a cover of the mirror base.

11. Exterior rearview mirror according to claim 1, wherein the opposing stop is provided on the mirror base.

12. Exterior rearview mirror according to claim 1, wherein the stop is provided on the mirror body.

13. Exterior rearview mirror according to claim 1, wherein the mirror body is hinged to the mirror base by means of at least one intermediate link.

14. Exterior rearview mirror according to claim 13, wherein the mirror body can pivot with respect to the mirror base through the intermediate link, both toward and away from the vehicle's direction of travel (F), around the respective axes.

15. Exterior rearview mirror according to claim 13, wherein the stop is provided on the intermediate link.

16. Exterior rearview mirror according to claim 1, wherein the noise damping device is provided on the mirror base or on the mirror body or on the intermediate link.

17. Exterior rearview mirror according to claim 1, wherein the noise damping device is designed as a single piece with the mirror base or the mirror body or the intermediate link.

18. Exterior rearview mirror according to claim 1, wherein the noise damping device is a separate component.

19. Exterior rearview mirror according to claim 1, wherein the noise damping device extends essentially over the entire length of the stop and opposing stop in the operating position of the mirror body.

20. Mirror according to claim 1, wherein at least part of the noise damping device is designed in the manner of a bellows.

21. Mirror according to claim 20, wherein at least the bellows-like part of the noise damping device is made of elastomeric material.

22. Exterior rearview mirror according to claim 20, wherein the noise damping device rests against the intermediate link under elastic deformation when the mirror body is in the operating position.

23. Exterior rearview mirror according to claim 1, wherein the stop is surrounded at a distance by the noise damping device.

24. Exterior rearview mirror, especially according to claim 1, wherein the noise damping device covers the contact area sufficiently that sound waves arising at the contact area are at least largely absorbed.
